(19) United States
(12) Patent Application Publication
(10) Pub. No.: US 2019/0139500 A1
(43) Pub. Date: May 9, 2019

(54) DISPLAY APPARATUS AND CONTROL METHOD THEREOF

(71) Applicant: CANON KABUSHIKI KAISHA, Tokyo (JP)

(72) Inventors: Mitsuru Tada, Machida-shi (JP); Tetsu Kitani, Kawasaki-shi (JP); Yasuhiro Matsuura, Yokohama-shi (JP)

(21) Appl. No.: 16/173,113

(22) Filed: Oct. 29, 2018

(30) Foreign Application Priority Data
Nov. 9, 2017 (JP) 2017-216158
Apr. 19, 2018 (JP) 2018-080548

(51) Int. Cl. G09G 3/36; G09G 3/34

(52) U.S. Cl. CPC G09G 3/36; G09G 3/3406; G09G 2320/028; G09G 2354/00; G09G 2320/068; G09G 2320/0673

(57) ABSTRACT

A display apparatus includes: a backlight module; a first panel transmitting a light from the backlight module based on a first image data; a second panel transmitting a light from the first panel based on a second image data; and at least one processor and/or at least one circuit to perform the operations of the following units: an acquiring unit configured to acquire an input image data; and a generating unit configured to generate the first image data and the second image data based on the input image data, wherein the generating unit generates the first image data and the second image data such that a decline in transmittance of the second panel due to an increase in a line-of-sight angle becomes larger than a decline in transmittance of the first panel due to the increase in the line-of-sight angle.

### BACKGROUND OF THE INVENTION

### Field of the Invention

The present invention relates to a display apparatus and a control method thereof.

### Description of the Related Art

Recently, a double liquid crystal technique in which two liquid crystal panels are used after being stacked on top of each other is being put to practical use as a technique for realizing high contrast display by a liquid crystal display apparatus. Since each liquid crystal panel is structured such that a liquid crystal layer is sandwiched between two glass plates, a space is created between the two liquid crystal layers respectively corresponding to the two liquid crystal panels. Therefore, when transmittances of the respective liquid crystal panels are controlled to the same transmittance, an image displayed on a rear surface-side liquid crystal panel does not overlap with an image displayed on a front surface-side liquid crystal panel and a double image is observed when a screen is viewed obliquely.

As a technique for reducing the double image, a technique involving reducing a spatial frequency of an image displayed on the rear surface-side liquid crystal panel is proposed. However, using such a technique results in an occurrence of a halo phenomenon in an image displayed on the screen (display image) and causes a contrast of the display image to decline. A halo phenomenon refers to a phenomenon in which a periphery of a bright part blurs brightly.

As a technique for solving these problems, a technique is proposed which involves switching display modes between a wide viewing angle mode and a narrow viewing angle mode in accordance with contents (a text, a graphic pattern, a natural image, and the like) of an input image (Japanese Patent Application Laid-open No. 2017-26992). A spatial frequency of an image displayed on a rear surface-side liquid crystal panel is only reduced in the narrow viewing angle mode.

As another technique, a technique is proposed which involves detecting maximum transmittance (a maximum gradation value) of an input image and controlling transmittance of a rear surface-side liquid crystal panel to transmittance equal to or higher than the detected maximum gradation value (Japanese Patent Application Laid-open No. 2013-156658).

### SUMMARY OF THE INVENTION

However, with the technique disclosed in Japanese Patent Application Laid-open No. 2017-26992, when a text and a natural image are both present in an input image, reduction of a double image and high contrast display cannot be both realized regardless of which display mode between the wide viewing angle mode and the narrow viewing angle mode is being set. With the technique disclosed in Japanese Patent Application Laid-open No. 2013-156658, the transmittance of the rear surface-side liquid crystal panel is increased. Therefore, when a spatial frequency of an image displayed on the rear surface-side liquid crystal panel is reduced, a halo phenomenon occurs more prominently. In addition, unless the spatial frequency of the image displayed on the rear surface-side liquid crystal panel is reduced, a double image occurs more prominently. As described above, with conventional techniques, reduction of a double image and suppression of other types of image quality deterioration (an occurrence of a halo phenomenon, a decline in contrast, and the like) cannot be realized at the same time.

The present invention in its first aspect provides a display apparatus comprising:

a backlight module;

a first panel transmitting a light from the backlight module based on a first image data;

a second panel displaying an image on a display area by transmitting a light from the first panel based on a second image data; and

at least one processor and/or at least one circuit to perform the operations of the following units:

an acquiring unit configured to acquire an input image data; and

a generating unit configured to generate the first image data and the second image data based on the input image data,

wherein the generating unit generates the first image data and the second image data such that a decline in transmittance of the second panel due to an increase in a line-of-sight angle which is an angle of a line-of-sight direction relative to the display area becomes larger than a decline in transmittance of the first panel due to the increase in the line-of-sight angle.

The present invention in its second aspect provides a display apparatus comprising:

a backlight module:

a first panel transmitting a light from the backlight module based on a first image data;

a second panel displaying an image on a display area by transmitting a light from the first panel based on a second image data; and

at least one processor and/or at least one circuit to perform the operations of the following units:

a first acquiring unit configured to acquire an input image data;

a second acquiring unit configured to acquire a parameter corresponding to a temperature of the display apparatus; and

a generating unit configured to generate the first image data and the second image data from the input image data based on the parameter.

The present invention in its third aspect provides a control method for a display apparatus including a backlight module, a first panel transmitting a light from the backlight module based on a first image data, and a second panel displaying an image on a display area by transmitting a light from the first panel based on a second image data, the control method comprising:

acquiring an input image data and

generating the first image data and the second image data based on the input image data,

wherein the first image data and the second image data are generated such that a decline in transmittance of the second panel due to an increase in a line-of-sight angle which is an angle of a line-of-sight direction relative to the display area becomes larger than a decline in transmittance of the first panel due to the increase in the line-of-sight angle.

The present invention in its fourth aspect provides a control method for a display apparatus including a backlight module, a first panel transmitting a light from the backlight module based on a first image data, and a second panel displaying an image on a display area by transmitting a light from the first panel based on a second image data, the control method comprising:

acquiring an input image data,

acquiring a parameter corresponding to a temperature of the display apparatus; and

generating the first image data and the second image data from the input image data based on the parameter.

The present invention in its fifth aspect provides a non-transitory computer readable medium that stores a program, wherein

the program causes a computer to execute a control method for a display apparatus including a backlight module, a first panel transmitting a light from the backlight module based on a first image data, and a second panel displaying an image on a display area by transmitting a light from the first panel based on a second image data,

the control method includes:

acquiring an input image data; and

generating the first image data and the second image data based on the input image data, and

the first image data and the second image data are generated such that a decline in transmittance of the second panel due to an increase in a line-of-sight angle which is an angle of a line-of-sight direction relative to the display area becomes larger than a decline in transmittance of the first panel due to the increase in the line-of-sight angle.

The present invention in its sixth aspect provides a non-transitory computer readable medium that stores a program, wherein

the program causes a computer to execute a control method for a display apparatus including a backlight module, a first panel transmitting a light from the backlight module based on a first image data, and a second panel displaying an image on a display area by transmitting a light from the first panel based on a second image data.

the control method includes:

acquiring an input image data;

acquiring a parameter corresponding to a temperature of the display apparatus; and

generating the first image data and the second image data from the input image data based on the parameter.

Further features of the present invention will become apparent from the following description of exemplar) embodiments with reference to the attached drawings.

### BRIEF DESCRIPTION OF THE DRAWINGS

FIG. 1 shows a configuration example of a display apparatus according to a first embodiment;

FIG. 2 shows an example of a correspondence relationship between double image reduction information and a γ value according to the first embodiment;

FIG. 3 shows an example of a correspondence relationship between transmittance and a line-of-sight angle according to the first embodiment:

FIG. 4 shows an example of a correspondence relationship among a gradation value, a line-of-sight angle, and transmittance according to the first embodiment;

FIG. 5 shows an example of a correspondence relationship between a first γ value and a second γ value according to the first embodiment;

FIGS. 6A and 6B show an example of input image data according to the first embodiment:

FIG. 7 is a diagram showing an example of a light beam according to the first embodiment;

FIGS. 8A and 8B show an example of image display according to conventional art;

FIGS. 9A and 9B show an example of image display according to the first embodiment;

FIGS. 10A and 10B show an example of image display according to conventional art;

FIGS. 11A and 11B show an example of image display according to the first embodiment;

FIG. 12 shows a configuration example of another display apparatus according to a first embodiment;

FIG. 13 shows a configuration example of a display apparatus according to a second embodiment;

FIG. 14 shows a configuration example of a display apparatus according to a third embodiment;

FIG. 15 shows an example of a correspondence relationship between liquid crystal panel temperature and a γ value according to the third embodiment; and

FIG. 16 shows a configuration example of a display apparatus according to a fourth embodiment.

### DESCRIPTION OF THE EMBODIMENTS

### First Embodiment

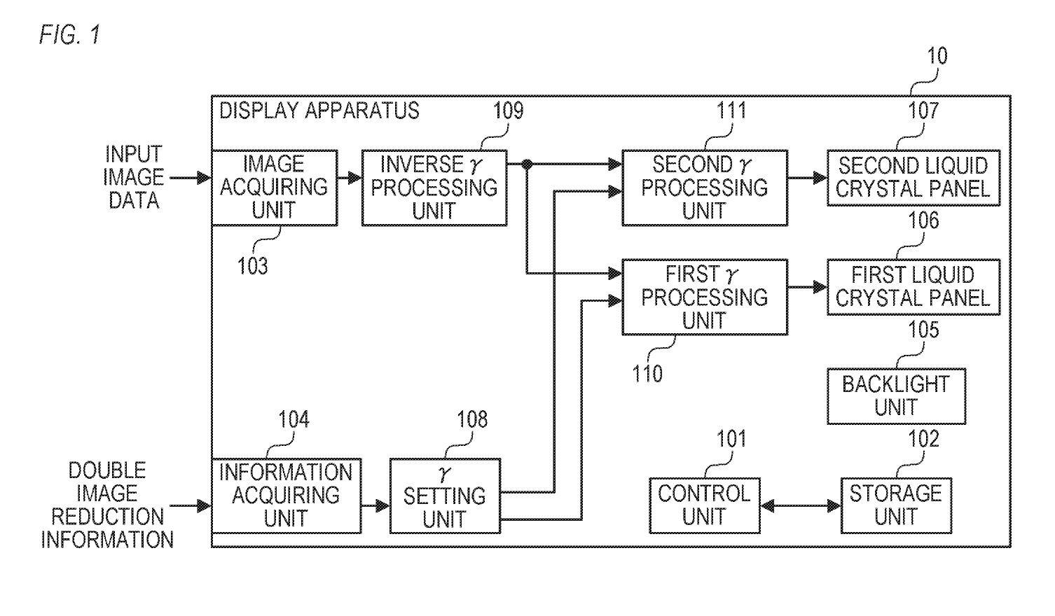

A first embodiment of the present invention will be described below. FIG. 1 is a block diagram showing a configuration example of a display apparatus 10 according to the present embodiment. The display apparatus 10 includes a control unit 101, a storage unit 102, an image acquiring unit 103, an information acquiring unit 104, a backlight unit (a backlight module) 105, a first liquid crystal panel 106, a second liquid crystal panel 107, a γ setting unit 108, an inverse γ processing unit 109, a first γ processing unit 110, and a second γ processing unit 111.

The control unit 101 controls processes of the respective functional units of the display apparatus 10. In FIG. 1, an arrow indicating an output of a control signal from the control unit 101 to each functional unit has been omitted. The storage unit 102 stores various types of data (a program, information, a parameter, and the like). For example, the control unit 101 controls processes of the respective functional units of the display apparatus 10 by reading a program from the storage unit 102 and executing the program. The storage unit 102 may be built into the display apparatus 10 or may be attachable to and detachable from the display apparatus 10. A plurality of storage units may be used as the storage unit 102. A part of the plurality of storage units may be built into the display apparatus 10 and a remainder of the plurality of storage units may be attachable to and detachable from the display apparatus 10.

The image acquiring unit 103 acquires image data (input image data; an input image signal) from outside of the display apparatus 10 and outputs the input image data to the inverse γ processing unit 109. Alternatively, the image acquiring unit 103 may acquire the input image data from the storage unit 102.

The information acquiring unit 104 acquires (generates) double image reduction information indicating a degree of reduction of a double image in accordance with a user operation. Specifically, the information acquiring unit 104 acquires double image reduction information indicating a degree of reduction specified by a user. In addition, the information acquiring unit 104 outputs the double image reduction information to the γ setting unit 108. Alternatively, the information acquiring unit 104 may acquire the double image reduction information from outside of the display apparatus 10 or may acquire the double image reduction information from the storage unit 102.

The backlight unit 105 is a light-emitting unit that irradiates light on a rear surface of the first liquid crystal panel 106. Hereinafter, a direction from the backlight unit 105 toward a screen (a surface viewed by the user; a display area) will be described as a forward direction.

The first liquid crystal panel 106 is a liquid crystal panel provided on a front side relative to the backlight unit 105. The first liquid crystal panel 106 transmits, at transmittance based on input image data (specifically, first processed image data (a first image signal) output from the first γ processing unit 110), light emitted from the backlight unit 105.

The second liquid crystal panel 107 is a liquid crystal panel provided on a front side relative to the first liquid crystal panel 106. The second liquid crystal panel 107 transmits, at transmittance based on input image data (specifically, second processed image data (a second image signal) output from the second γ processing unit 111), light emitted from the backlight unit 105 and transmitted through the first liquid crystal panel 106. Accordingly, an image based on the input image data is displayed on a screen. For example, the screen is a front surface of the second liquid crystal panel 107.

In the present embodiment, an example of so-called normally black will be described in which the larger a gradation value of the input image data, the higher a brightness of the input image data, transmittance of the first liquid crystal panel 106, transmittance of the second liquid crystal panel 107, and the like. Moreover, in the present embodiment, it is assumed that the first liquid crystal panel 106 and the second liquid crystal panel 107 are liquid crystal panels of a same type. With the first liquid crystal panel 106 and the second liquid crystal panel 107, the larger the gradation value of the input image data, the higher the transmittance, and the transmittance takes a maximum value when the gradation value takes a maximum value. Therefore, the first liquid crystal panel 106 and the second liquid crystal panel 107 can be described such that the larger the gradation value of the input image data, the higher a ratio of the transmittance to a maximum value of possible transmittances.

Alternatively, at least one of the first liquid crystal panel 106 and the second liquid crystal panel 107 may not be a liquid crystal panel. Various transmission panels that transmit light at transmittance based on the input image data can be used as the first liquid crystal panel 106 and the second liquid crystal panel 107. For example, at least one of the first liquid crystal panel 106 and the second liquid crystal panel 107 may be a MEMS (Micro Electro Mechanical System) shutter-system display panel.

Moreover, in the present embodiment, the first liquid crystal panel 106 and the second liquid crystal panel 107 each have transmission characteristics such that the higher the transmittance (perpendicular transmittance) of light in a direction (a front direction) perpendicular to the screen, the lower a ratio of oblique transmittance to the perpendicular transmittance. The oblique transmittance is transmittance of light in a direction having a prescribed angle relative to the direction perpendicular to the screen. In other words, with each of the first liquid crystal panel 106 and the second liquid crystal panel 107, the higher the perpendicular transmittance, the lower (more inferior) the viewing angle characteristics.

Viewing angle characteristics of the first liquid crystal panel 106 and the second liquid crystal panel 107 will be described with reference to a drawing. FIG. 3 is a schematic view showing an example of a correspondence relationship between a line-of-sight angle and transmittance of a liquid crystal panel (liquid crystal elements of a liquid crystal panel) in a direction of each line-of-sight angle. In other words, FIG. 3 is a schematic view showing a correspondence relationship between a line-of-sight angle with respect to a given liquid crystal element of a liquid crystal panel and transmittance of the liquid crystal element. An abscissa in FIG. 3 represents a line-of-sight angle and an ordinate in FIG. 3 represents transmittance of the liquid crystal panel at each line-of-sight angle. The line-of-sight angle is an angle of a direction of a line of sight relative to the screen. In the present embodiment, the line-of-sight angle is an angle of a direction of a line of sight relative to a direction perpendicular to the screen (the front direction) and is an angle in which the front direction is represented as 0 degrees. A state where the line-of-sight angle is larger than 0 degrees and smaller than 90 degrees is a state where the screen of the liquid crystal panel is being viewed from an oblique direction relative to the screen. The transmittance shown in FIG. 3 is a value normalized so as to have a maximum value of 1. The liquid crystal panel is configured such that the transmittance (the perpendicular transmittance) thereof when the line-of-sight angle is 0 degrees takes a maximum value.

When a gradation value of image data input to the liquid crystal panel changes, voltage supplied to the liquid crystal panel changes and the transmittance (the perpendicular transmittance or the oblique transmittance) of the liquid crystal panel changes. Viewing angle characteristics 301 in FIG. 3 represent viewing angle characteristics when the transmittance of the liquid crystal panel is controlled based on image data of which the gradation value is an upper limit value. Viewing angle characteristics 302 in FIG. 3 represent viewing angle characteristics when the transmittance of the liquid crystal panel is controlled based on image data of which the gradation value is a lower limit value. As described above, with the liquid crystal panel used as the first liquid crystal panel 106 or the second liquid crystal panel 107 in the present embodiment, the larger the gradation value of the input image data, the higher the transmittance (the perpendicular transmittance or the oblique transmittance). Therefore, the viewing angle characteristics 301 can be described as viewing angle characteristics when the transmittance of the liquid crystal panel is controlled to high transmittance. In a similar manner, the viewing angle characteristics 302 can be described as viewing angle characteristics when the transmittance of the liquid crystal panel is controlled to low transmittance.

In the present embodiment, a state where a difference between the perpendicular transmittance and the oblique transmittance is small is considered a state where viewing angle characteristics are high (good). In such a state, differences in brightness and color between an image visible when viewing the screen from an oblique direction and an image visible when viewing the screen from the front direction are small. On the other hand, a state where the difference between the perpendicular transmittance and the oblique transmittance is large is considered a state where viewing angle characteristics are low (inferior). In such a state, differences in brightness and color between an image visible when viewing the screen from an oblique direction and an image visible when viewing the screen from the front direction are large.

As shown in FIG. 3, the viewing angle characteristics 301 when the transmittance of the liquid crystal panel is controlled to high transmittance is broader than the viewing angle characteristics 302 when the transmittance of the liquid crystal panel is controlled to low transmittance. Broad viewing angle characteristics mean that a change in transmittance due to a change in a line-of-sight angle is small and that the difference between the perpendicular transmittance and the oblique transmittance is small. Therefore, when the transmittance of the liquid crystal panel is controlled to high transmittance, viewing angle characteristics are lower than when the transmittance of the liquid crystal panel is controlled to low transmittance. In other words, in the liquid crystal panel, an increase in the gradation value causes viewing angle characteristics to deteriorate.

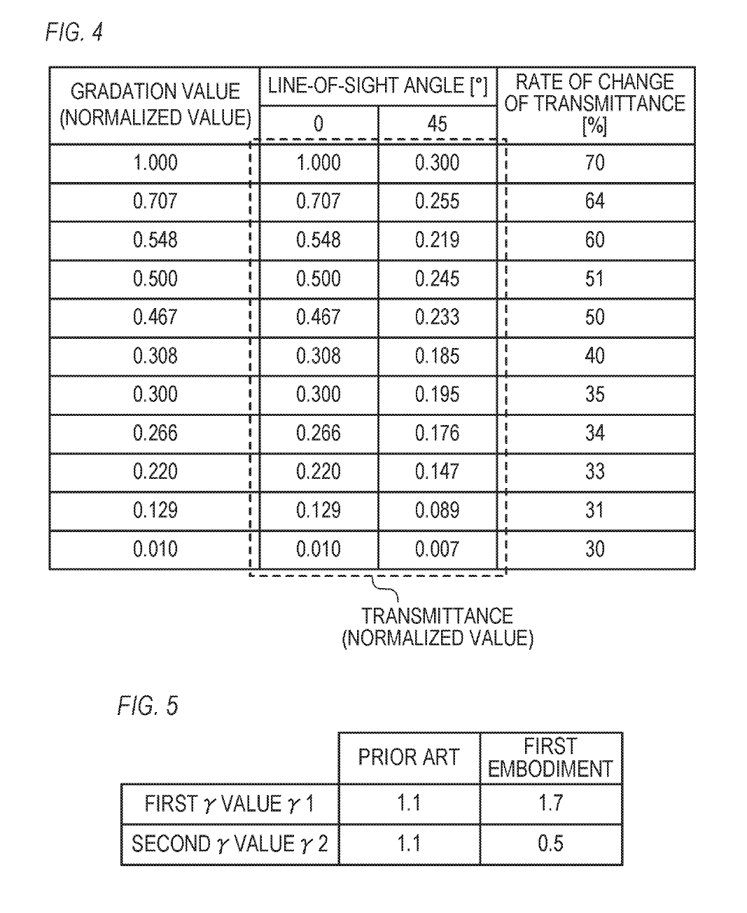

FIG. 4 shows a table representing an example of a correspondence relationship among a gradation value, a line-of-sight angle, transmittance of the liquid crystal panel, and a rate of change of transmittance. In FIG. 4, the gradation value is a value normalized so as to have a maximum value of 1, and the transmittance is also a value normalized so as to have a maximum value of 1. The maximum value of the transmittance represents transmittance of which the gradation value is controlled to the maximum value and of which the line-of-sight angle is 0 degrees (the front direction). FIG. 4 shows a case where the line-of-sight angle is 0 degrees (the front direction) and a case where the line-of-sight angle is 45 degrees. The rate of change of transmittance represents a rate of the transmittance at the line-of-sight angle of 45 degrees (a prescribed angle) to the transmittance at the line-of-sight angle of 0 degrees. The smaller the rate of change of transmittance, the larger the difference between front transmittance and oblique transmittance and, therefore, the more inferior the viewing angle characteristics. FIG. 4 reveals that, as the gradation value increases and a ratio of the perpendicular transmittance to the maximum value of the perpendicular transmittance increases, the rate of change of transmittance declines and the viewing angle characteristics decline. Moreover, the prescribed angle of the oblique transmittance need only not be 0 degrees and may be larger or smaller than 45 degrees.

The γ setting unit 108 sets γ values (γ1 and γ2) to be used by the respective γ processing units (to be described later) to generate processed image data. The γ setting unit 108 sets the γ values such that the viewing angle characteristics of the second liquid crystal panel 107 drop below the viewing angle characteristics of the first liquid crystal panel 106. As described above, with the first liquid crystal panel 106 and the second liquid crystal panel 107, the higher the input gradation value, the larger the ratio of the perpendicular transmittance to the maximum value of the perpendicular transmittance and the lower the viewing angle characteristics. Therefore, the γ setting unit 108 sets each γ value so that each liquid crystal element of the second liquid crystal panel 107 is controlled at a higher gradation value than a corresponding liquid crystal element of the first liquid crystal panel 106. Specifically, the γ setting unit 108 sets each γ value so that the γ value (γ2) for generating image data to be used to control the second liquid crystal panel 107 becomes larger than the γ value (γ1) for generating image data to be used to control the first liquid crystal panel 106. Accordingly, the ratio of the perpendicular transmittance of each liquid crystal element of the second liquid crystal panel 107 to the maximum value of the perpendicular transmittance of the second liquid crystal panel 107 becomes higher than the ratio of the perpendicular transmittance of each liquid crystal element of the first liquid crystal panel 106 to the maximum value of the perpendicular transmittance of the first liquid crystal panel 106.

The larger the γ value, the higher the gradation value at which transmittance is controlled. Therefore, the larger the γ value, the lower the viewing angle characteristics of a realized state. In other words, the γ values (γ1 and γ2) set by the γ setting unit 108 are measures indicating a degree of decline in the viewing angle characteristics of each liquid crystal panel (a degree of decline in transmittance relative to a change in the viewing angle).

In the present embodiment, a degree of decline in the transmittance of the first liquid crystal panel 106 due to an increase in the line-of-sight angle is considered a first measure and a degree of decline in the transmittance of the second liquid crystal panel 107 due to an increase in the line-of-sight angle is considered a second measure. In addition, the γ setting unit 108 sets the first measure and the second measure in accordance with a user operation (specifically, double image reduction information output from the information acquiring unit 104). Specifically, in accordance with the double image reduction information, the γ setting unit 108 determines a first γ value (a first gamma parameter) γ1 as the first measure and determines a second γ value (a second gamma parameter) γ2 as the second measure. Furthermore, the γ setting unit 108 outputs the first γ value γ to the first γ processing unit 110 and outputs the second γ value γ2 to the second γ processing unit 111.

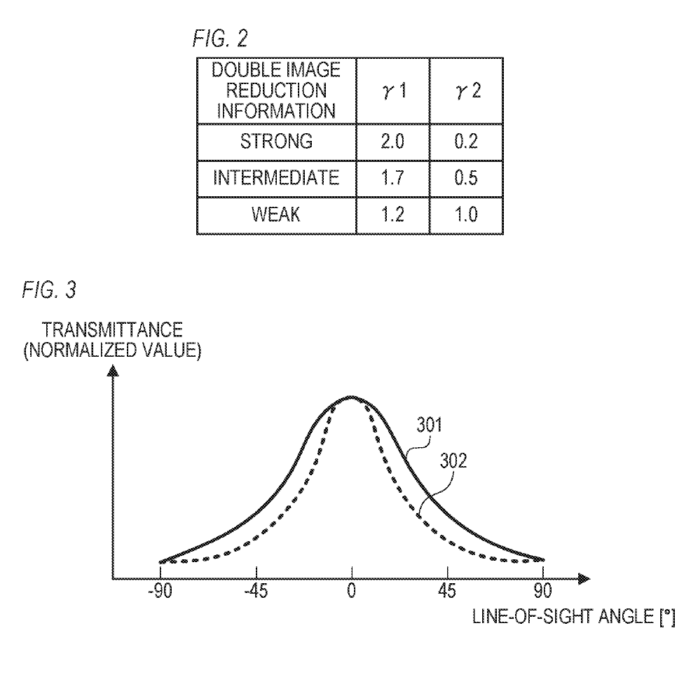

FIG. 2 is a table showing an example of a correspondence relationship among double image reduction information (a degree of reduction of a double image), the first γ value γ1, and the second γ value γ2. For example, the γ setting unit 108 determines the first γ value γ1 and the second γ value γ2 using the table shown in FIG. 2. In the present embodiment, as shown in FIG. 2, a γ value smaller than the first γ value γ1 is determined as the second γ value γ2. In addition, a γ value that is smaller when the degree of reduction indicated by the double image reduction information is higher is determined as the second γ value γ2. In the example shown in FIG. 2, the first γ value γ1 and the second γ value γ2 are determined so that γ characteristics of a double liquid crystal panel constituted by the first liquid crystal panel 106 and the second liquid crystal panel 107 are γ characteristics expressed as γ value=γ1+γ2=2.2.

The inverse γ processing unit 109 generates linear image data by performing an inverse γ conversion process of converting the γ characteristics of the input image data output from the image acquiring unit 103 into linear characteristics in which the brightness of image data linearly increases relative to an increase in the gradation value. In addition, the inverse γ processing unit 109 outputs the linear image data to the first γ processing unit 110 and the second γ processing unit 111. While a data format of the input image data is not particularly limited, in the present embodiment, it is assumed that a pixel value of the input image data is an RGB value constituted by an 8-bit R value, an 8-bit G value, and an 8-bit B value and that the γ value of the input image data is 2.2. In addition, the inverse γ processing unit 109 converts each pixel value of the input image data using expressions 1 to 3 below. In expressions 1 to 3, “IV_Rmn” denotes an input R value (an R value of the input image data) of an m-th row, n-th column pixel. “IV_Gmn” denotes an input G value (a G value of the input image data) of the m-th row, n-th column pixel. “IV_Bmn” denotes an input B value (a B value of the input image data) of the m-th row, n-th column pixel. “GV_Rmn” denotes a linear R value (an R value of linear image data) of the m-th row, n-th column pixel. “GV_Gmn” denotes a linear G value (a G value of the linear image data) of the m-th row, n-th column pixel. In addition. “GV_Bmn” denotes a linear B value (a B value of the linear image data) of the m-th row, n-th column pixel. A calculation using the expressions 1 to 3 generates linear image data of which a pixel value is an RGB value constituted by an 8-bit R value, an 8-bit G value, and an 8-bit B value and a γ value is 2.2. Moreover, a data format of the linear image data is not particularly limited.

GV_Rmn=255×(IV_Rmn/255)^{2.2} (expression 1)

GV_Gmn=255×(IV_Gmn/255)^{2.2} (expression 2)

GV_Bmn=255×(IV_Bmn/255)^{2.2} (expression 3)

The first γ processing unit 110 generates first processed image data by performing a first process of converting each gradation value of the input image data (specifically, linear image data output from the inverse γ processing unit 109) so as to satisfy a condition described below. In addition, the first γ processing unit 110 outputs the first processed image data to the first liquid crystal panel 106. The following condition may be restated as “the viewing angle characteristics of the second liquid crystal panel 107 is more inferior than the viewing angle characteristics of the first liquid crystal panel 106”.

Condition: a decline in the transmittance of the second liquid crystal panel 107 due to an increase in a line-of-sight angle is larger than a decline in the transmittance of the first liquid crystal panel 106 due to an increase in the line-of-sight angle.

Specifically, the first γ processing unit 110 generates the first processed image data by performing a γ conversion process using the first γ value γ1 output from the γ setting unit 108 on the input image data (specifically, linear image data). In the present embodiment, the first γ processing unit 110 converts each pixel value of the linear image data using expressions 4 to 6 below. In expressions 4 to 6, “GP1_Rmn” denotes a first R value (an R value of the first processed image data) of an m-th row, n-th column pixel. “GP1_Gmn” denotes a first G value (a G value of the first processed image data) of the m-th row, n-th column pixel. In addition, “GP1_Bmn” denotes a first B value (a B value of the first processed image data) of the m-th row, n-th column pixel. A calculation using the expressions 4 to 6 generates first processed image data of which a pixel value is an RGB value constituted by an 8-bit R value, an 8-bit G value, and an 8-bit B value. Moreover, a data format of the first processed image data is not particularly limited.

GP1_Rmn=255×(GV_Rmn/255)^{γ1} (expression 4)

GP1_Gmn=255×(GV_Gmn/255)^{γ1} (expression 5)

GP1_Bmn=255×(GV_Bmn/255)^{γ1} (expression 6)

The second γ processing unit 111 generates second processed image data by performing a second process of converting each gradation value of the input image data (specifically, linear image data output from the inverse γ processing unit 109) so as to satisfy the condition described above. In addition, the second γ processing unit 111 outputs the second processed image data to the second liquid crystal panel 107. Specifically, the second γ processing unit 111 generates the second processed image data by performing a γ conversion process using the second γ value γ2 output from the γ setting unit 108 on the input image data (specifically, linear image data). In the present embodiment, the second γ processing unit 111 converts each pixel value of the linear image data using expressions 7 to 9 below. In expressions 7 to 9, “GP2_Rmn” denotes a second R value (an R value of the second processed image data) of an m-th row, n-th column pixel. “GP2_Gmn” denotes a second G value (a G value of the second processed image data) of the m-th row, n-th column pixel. In addition, “GP2_Bmn” denotes a second B value (a B value of the second processed image data) of the m-th row, n-th column pixel. A calculation using the expressions 7 to 9 generates second processed image data of which a pixel value is an RGB value constituted by an 8-bit R value, an 8-bit G value, and an 8-bit B value. Moreover, a data format of the second processed image data is not particularly limited.

GP2_Rmn=255×(GV_Rmn/255)^{γ2} (expression 7)

GP2_Gmn=255×(GV_Gmn/255)^{γ2} (expression 8)

GP2_Bmn=255×(GV_Bmn/255)^{γ2} (expression 9)

FIG. 5 is a table showing an example of a correspondence relationship between the first γ value γ1 and a second γ value γ2. In conventional art, a same γ value as the first γ value γ 1 is used as the second γ value γ2. For example, as shown in FIG. 5, first γ value γ1=second γ value γ2=1.1 is used. On the other hand, in the present embodiment, a smaller γ value than the first γ value γ1 is used as the second γ value γ2. For example, as shown in FIG. 5, first γ value γ1=1.7 and second γ value γ2=0.5 are used. As described earlier, an increase in the gradation value causes viewing angle characteristics to deteriorate. Therefore, a decrease in the γ value causes viewing angle characteristics to deteriorate. In the present embodiment, since a smaller γ value than the first γ value γ1 is used as the second γ value γ2, the viewing angle characteristics of the second liquid crystal panel 107 are inferior to the viewing angle characteristics of the first liquid crystal panel 106. This can also be described as “the perpendicular transmittance of the second liquid crystal panel 107 is higher than the perpendicular transmittance of the first liquid crystal panel 106” and “the rate of change of transmittance of the second liquid crystal panel 107 is lower than the rate of change of transmittance of the first liquid crystal panel 106”. In the present embodiment, due to control by the control unit 101, transmittances of light of the first liquid crystal panel 106 and the second liquid crystal panel 107 are controlled based on input image data so as to satisfy the conditions described above with respect to viewing angle characteristics being good or inferior and the like.

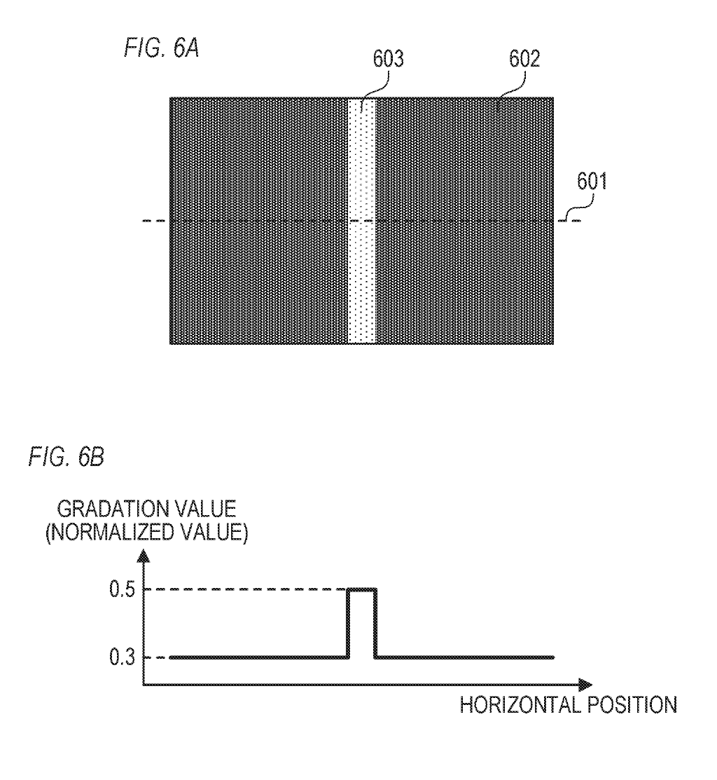

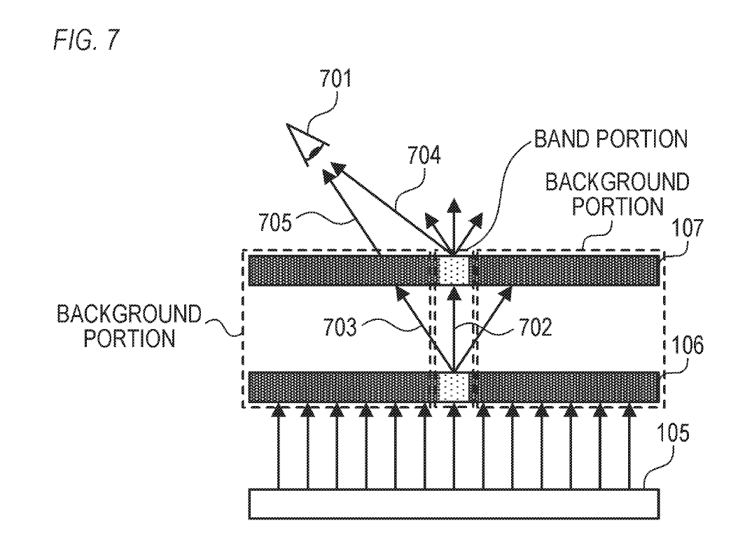

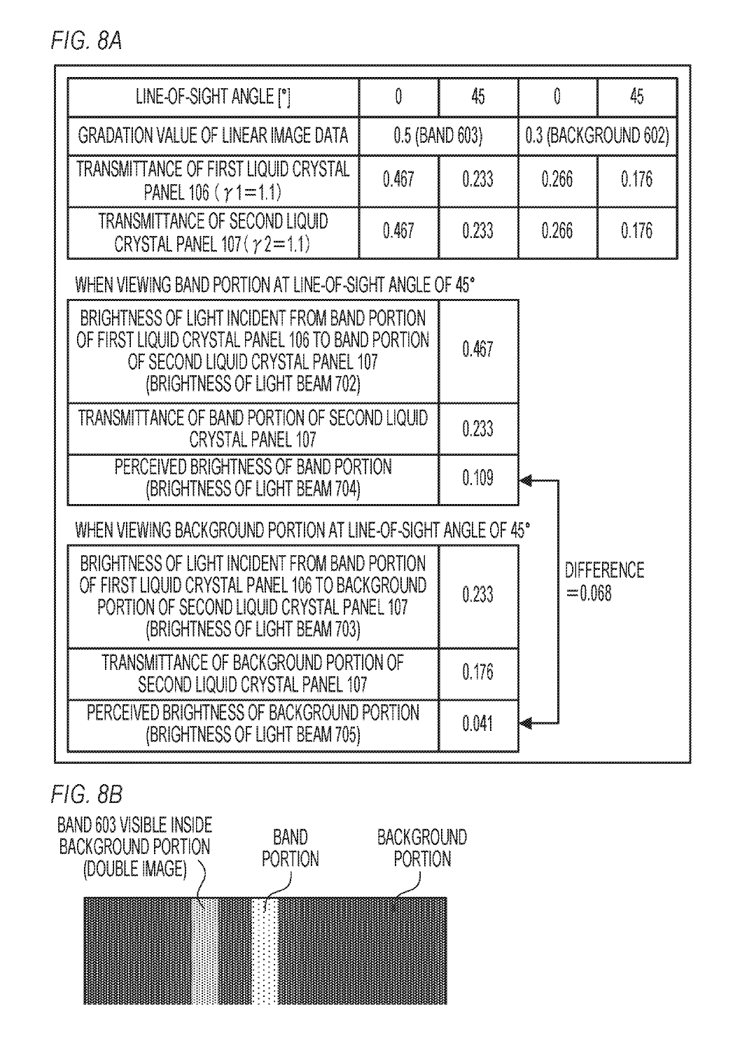

FIGS. 6A and 6B are schematic views showing an example of input image data (specifically, linear image data). FIG. 6A shows an example of an image represented by linear image data, and FIG. 6B shows an example of a distribution of gradation values (signal levels) of the linear image data on a dashed line 601 in FIG. 6A. An abscissa in FIG. 6B indicates a horizontal position in the image and an ordinate in FIG. 6B indicates a gradation value of the linear image data. In the example shown in FIGS. 6A and 6B, a band 603 with a gradation value of 0.5 is drawn on a background 602 with a gradation value of 0.3.

FIG. 7 is a schematic view showing an example of a light beam when an image based on the linear image data shown in FIG. 6 is displayed on a screen. An eye 701 of the user is viewing the screen at a line-of-sight angle of 45 degrees. A light beam 702 is a light beam transmitted through a band portion (a portion corresponding to the band 603) of the first liquid crystal panel 106 and incident to a band portion of the second liquid crystal panel 107. A light beam 703 is a light beam transmitted through the band portion of the first liquid crystal panel 106 and incident to a background portion (a portion corresponding to the background 602) of the second liquid crystal panel 107. After the light beam 702 is transmitted through the band portion of the first liquid crystal panel 106, the light beam 702 is incident to the eye 701 as a light beam 704. In addition, after the light beam 703 is transmitted through the background portion of the first liquid crystal panel 106, the light beam 703 is incident to the eye 701 as a light beam 705. As a result of the incidence of the light beams 704 and 705 transmitted through the band portion of the first liquid crystal panel 106 to the eye 701, a double image of the band 603 is observed by the user. Specifically, a band corresponding to the band 603 is observed in the band portion and the background portion.

FIGS. 8A and 8B are schematic views showing an example of image display according to conventional art. FIG. 8A shows an example of a correspondence relationship among the gradation value of linear image data, the transmittance of the first liquid crystal panel 106, the transmittance of the second liquid crystal panel 107, brightness of light incident from the first liquid crystal panel 106 to the second liquid crystal panel 107, a line-of-sight angle, brightness perceived by the user (perceived brightness), and the like. In FIG. 8A, the first γ value γ1 and the second γ value γ2 are both 1.1. In addition, in FIG. 8A, the brightness of light incident to the first liquid crystal panel 106 is set to 1 for the sake of simplicity. FIG. 8B shows an example of an image perceived when the user views the screen at a line-of-sight angle of 45 degrees. FIG. 8B represents an example of displaying an image based on the linear image data shown in FIG. 6 on the screen.

Since the first γ value γ1 is 1.1, the gradation value of 0.5 (the band 603) of the linear image data is converted into the gradation value of 0.467 (=0.5^{1.1}) of first processed image data. In addition, the gradation value of 0.3 (the background 602) of the linear image data is converted into the gradation value of 0.266 (=0.3^{1.1}) of the first processed image data. In a similar manner, since the second γ value γ2 is 1.1, the gradation value of 0.5 (the band 603) of the linear image data is converted into the gradation value of 0.467 (=0.5^{1.1}) of second processed image data. In addition, the gradation value of 0.3 (the background 602) of the linear image data is converted into the gradation value of 0.266 (=0.3^{1.1}) of the second processed image data.

First, a case of a line-of-sight angle of 0 degrees will be considered. In this case, as shown in FIG. 8A, the transmittance of the band portion (gradation value of 0.467) of the first liquid crystal panel 106 is 0.467 according to the table shown in FIG. 4. In a similar manner, the transmittance of the band portion (gradation value of 0.467) of the second liquid crystal panel 107 is 0.467 according to the table shown in FIG. 4. Therefore, the perceived brightness of the band portion is 0.218 (=0.467×0.467×1).

Next, a case where the band portion is viewed at a line-of-sight angle of 45 degrees will be considered. Light (the light beam 702) incident from the band portion of the first liquid crystal panel 106 to the band portion of the second liquid crystal panel 107 is light having been transmitted through the first liquid crystal panel 106 at the transmittance of 0.467 of the line-of-sight angle of 0 degrees. Therefore, the brightness of the light (the light beam 702) incident from the band portion of the first liquid crystal panel 106 to the band portion of the second liquid crystal panel 107 is 0.467 (=0.467×1). In addition, the transmittance of the band portion of the second liquid crystal panel 107 is the transmittance of 0.233 corresponding to the line-of-sight angle of 45 degrees and the gradation value of 0.467 in the table shown in FIG. 4. Therefore, the perceived brightness of the band portion (the brightness of the light beam 704) is 0.109 (=0.233×0.467).

Next, a case where the background portion (specifically, a portion into which light from the band portion of the first liquid crystal panel 106 leaks in the background portion) is viewed at the line-of-sight angle of 45 degrees will be considered. Light (the light beam 703) incident from the band portion of the first liquid crystal panel 106 to the background portion of the second liquid crystal panel 107 is light having been transmitted through the first liquid crystal panel 106 at the transmittance of 0.233 which corresponds to the line-of-sight angle of 45 degrees and the gradation value of 0.467 in the table shown in FIG. 4. Therefore, the brightness of the light (the light beam 703) incident from the band portion of the first liquid crystal panel 106 to the background portion of the second liquid crystal panel 107 is 0.233 (=0.233×1). In addition, the transmittance of the background portion of the second liquid crystal panel 107 is the transmittance of 0.176 (a rate of change of transmittance of 34%) corresponding to the line-of-sight angle of 45 degrees and the gradation value of 0.266 in the table shown in FIG. 4. Therefore, the perceived brightness of the background portion (the brightness of the light beam 705) is 0.041 (=0.176×0.233). As a result, when the line-of-sight angle is 45 degrees, as shown in FIG. 8B, the band 603 is observed not only in the band portion but also in the background portion at a perceived brightness of 0.041 and a double image is visible. Furthermore, when the screen is viewed at the line-of-sight angle of 45 degrees, a difference between the perceived brightness of the band portion (the brightness of the light beam 704) of 0.109 and the perceived brightness of the background portion (the brightness of the light beam 705) of 0.041 is 0.068 (=0.109−0.041). Therefore, as shown in FIG. 8B, the band 603 of the background portion (the light beam 705) appears bright and a double image becomes more visible.

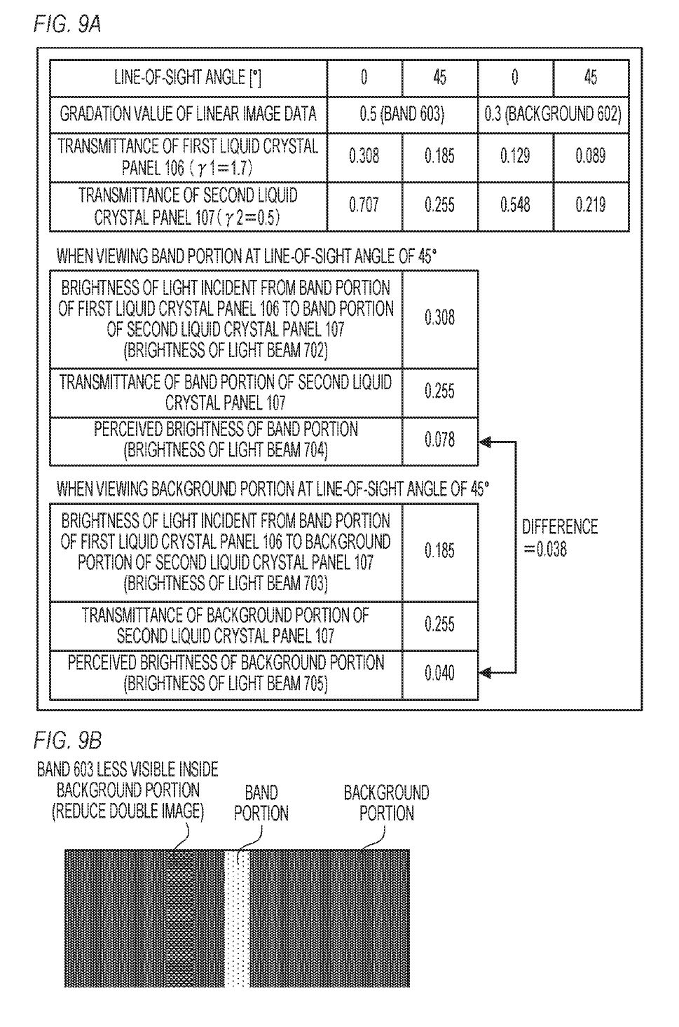

FIGS. 9A and 9B are schematic views showing an example of image display according to the present embodiment. FIG. 9A shows an example of a correspondence relationship among the gradation value of linear image data, the transmittance of the first liquid crystal panel 106, the transmittance of the second liquid crystal panel 107, brightness of light incident from the first liquid crystal panel 106 to the second liquid crystal panel 107, a line-of-sight angle, perceived brightness, and the like. In FIG. 9A, the first γ value γ1 is 1.7 and the second γ value γ2 is 0.5. In addition, in FIG. 9A, brightness of light incident to the first liquid crystal panel 106 is set to 1 for the sake of simplicity. FIG. 9B shows an example of an image perceived when the user views the screen at a line-of-sight angle of 45 degrees. FIG. 9B represents an example of displaying an image based on the linear image data shown in FIG. 6 on the screen.

Since the first γ value γ1 is 1.7, the gradation value of 0.5 (the band 603) of the linear image data is converted into the gradation value of 0.308 (=0.5′) of first processed image data. In addition, the gradation value of 0.3 (the background 602) of the linear image data is converted into the gradation value of 0.129 (=0.3^{1.7}) of the first processed image data. In a similar manner, since the second γ value γ2 is 0.5, the gradation value of 0.5 (the band 603) of the linear image data is converted into the gradation value of 0.707 (=0.5^{0.5}) of second processed image data. In addition, the gradation value of 0.3 (the background 602) of the linear image data is converted into the gradation value of 0.548 (=0.3^{0.5}) of the second processed image data.

First, a case of a line-of-sight angle of 0 degrees will be considered. In this case, as shown in FIG. 9A, the transmittance of the band portion (gradation value of 0.308) of the first liquid crystal panel 106 is 0.308 according to the table shown in FIG. 4. In a similar manner, the transmittance of the band portion (gradation value of 0.707) of the second liquid crystal panel 107 is 0.707 according to the table shown in FIG. 4. Therefore, the perceived brightness of the band portion is 0.218 (=0.308×0.707×1). The perceived brightness of 0.218 of the band portion is equal to the perceived brightness of 0.218 according to conventional art (FIGS. 8A and 8B). In other words, when the line-of-sight angle is 0 degrees, an image equivalent to an image according to conventional art can be perceived.

Next, a case where the band portion is viewed at a line-of-sight angle of 45 degrees will be considered. Light (the light beam 702) incident from the band portion of the first liquid crystal panel 106 to the band portion of the second liquid crystal panel 107 is light having been transmitted through the first liquid crystal panel 106 at the transmittance of 0.308 of the line-of-sight angle of 0 degrees. Therefore, the brightness of the light (the light beam 702) incident from the band portion of the first liquid crystal panel 106 to the band portion of the second liquid crystal panel 107 is 0.308 (=0.308×1). In addition, the transmittance of the band portion of the second liquid crystal panel 107 is the transmittance of 0.255 corresponding to the line-of-sight angle of 45 degrees and the gradation value of 0.707 in the table shown in FIG. 4. Therefore, the perceived brightness of the band portion (the brightness of the light beam 704) is 0.078 (=0.255×0.308). Note that “0.255“is a simplified numerical value of”0.254558441227157” and “0.308” is a simplified numerical value of “0.307786103336229”.

Next, a case where the background portion (specifically, a portion into which light from the band portion of the first liquid crystal panel 106 leaks in the background portion) is viewed at the line-of-sight angle of 45 degrees will be considered. Light (the light beam 703) incident from the band portion of the first liquid crystal panel 106 to the background portion of the second liquid crystal panel 107 is light having been transmitted through the first liquid crystal panel 106 at the transmittance of 0.185 which corresponds to the line-of-sight angle of 45 degrees and the gradation value of 0.308 in the table shown in FIG. 4. Therefore, the brightness of the light (the light beam 703) incident from the band portion of the first liquid crystal panel 106 to the background portion of the second liquid crystal panel 107 is 0.185 (=0.185×1). In addition, the transmittance of the background portion of the second liquid crystal panel 107 is the transmittance of 0.255 (a rate of change of transmittance of 64%) corresponding to the line-of-sight angle of 45 degrees and the gradation value of 0.707 in the table shown in FIG. 4. Since the second γ value γ2=0.5 is smaller than the second γ value γ2=1.1 according to conventional art (FIGS. 8A and 8B), the rate of change of transmittance of 64% which is larger than the rate of change of transmittance of 34% according to conventional art is realized as the rate of change of transmittance of the second liquid crystal panel 107. In addition, the perceived brightness of the background portion (the brightness of the light beam 705) is 0.040 (=0.219×0.185). Note that “0.219” is a simplified numerical value of “0.219089023002066” and “0.185” is a simplified numerical value of “0.184671662001737”.

The perceived brightness of 0.040 of the band 603 in the background portion is lower than the perceived brightness of 0.041 according to conventional art (FIGS. 8A and 8B). Therefore, as shown in FIG. 9B, a double image can be made less visible. In the present embodiment, by reducing the second γ value γ2, the rate of change of transmittance is reduced and the perceived brightness of the band 603 in the background portion is reduced. In addition, by increasing the first γ value γ1, the transmittance of the first liquid crystal panel 106 is reduced and the perceived brightness of the band 603 in the background portion is reduced. In other words, the perceived brightness of the band 603 in the background portion is reduced by a synergistic effect of the first liquid crystal panel 106 and the second liquid crystal panel 107. Furthermore, when the screen is viewed at the line-of-sight angle of 45 degrees, a difference between the perceived brightness of the band portion (the brightness of the light beam 704) of 0.078 and the perceived brightness of the background portion (the brightness of the light beam 705) of 0.040 is 0.038 (=0.078-0.040) which is smaller than the difference of 0.068 according to conventional art. This also contributes to making a double image less visible. In this manner, a double image can be made less visible due to a reduction in the perceived brightness of the band 603 (the light beam 705) in the background portion and a reduction in the difference between the perceived brightness of the band 603 (the light beam 705) in the background portion and the perceived brightness of the band portion (the light beam 704).

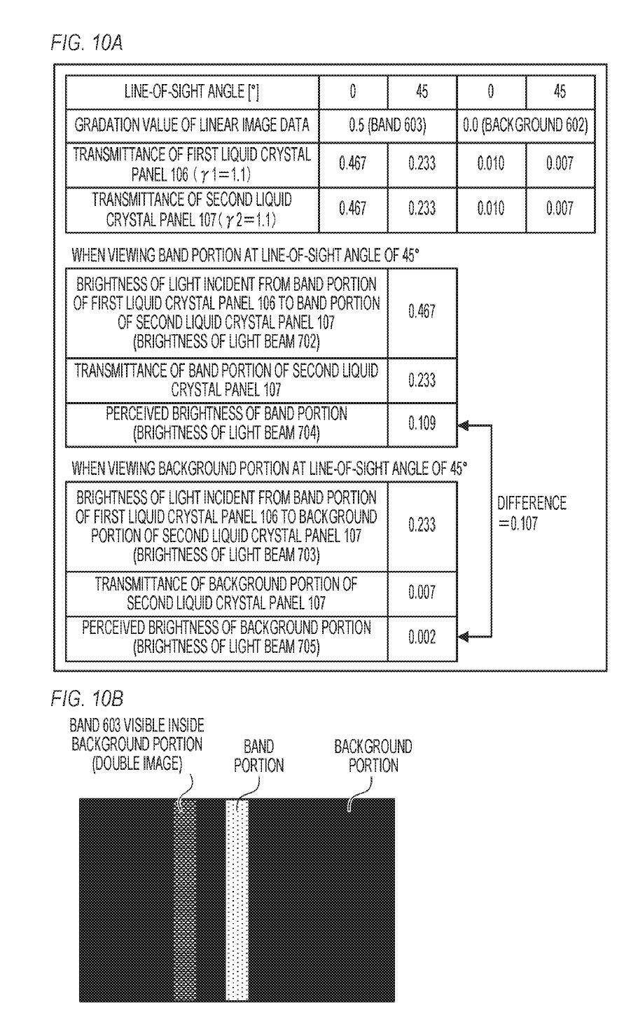

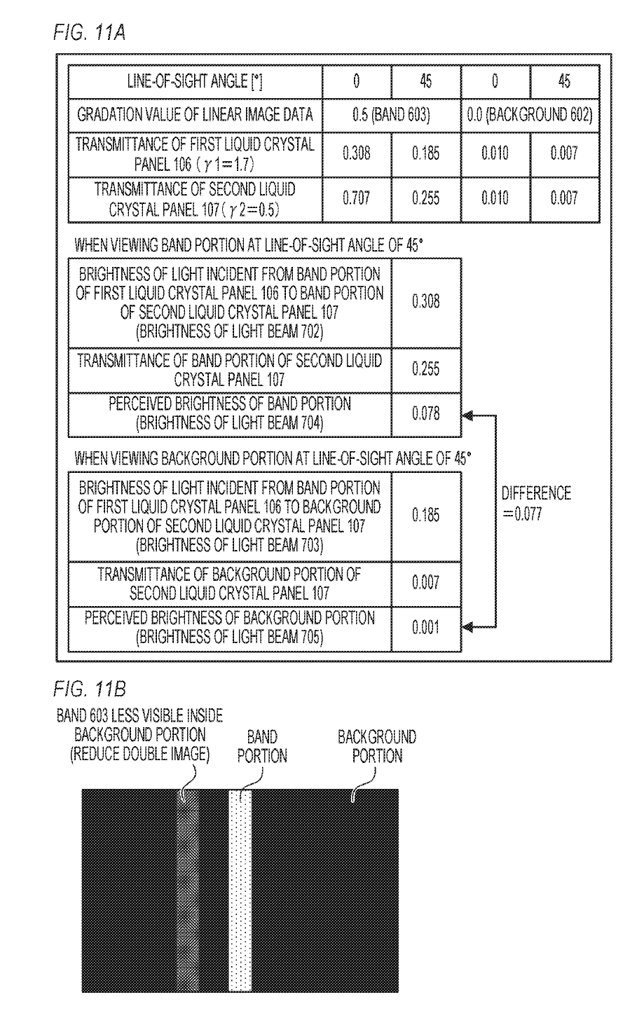

Next, the fact that a similar effect to that described above can be obtained even when the gradation value of the linear image data shown in FIG. 6 differs from the gradation value described above will be described with reference to FIGS. 10A. 10B, 11A, and 11B. Specifically, an example in which the gradation value of the background 602 is 0.0 will be described. Note that descriptions of points similar to FIGS. 8A. 8B, 9A, and 9B will be omitted when appropriate. In addition, the gradation value of 0.0 (the background 602) of the linear image data remains the gradation value of 0.0 in both first processed image data and second processed image data.

FIGS. 10A and 10B are schematic views showing an example of image display according to conventional art. FIG. 10A shows an example of a correspondence relationship among the gradation value of linear image data, the transmittance of the first liquid crystal panel 106, the transmittance of the second liquid crystal panel 107, brightness of light incident from the first liquid crystal panel 106 to the second liquid crystal panel 107, a line-of-sight angle, perceived brightness, and the like. FIG. 10B shows an example of an image perceived when the user views the screen at a line-of-sight angle of 45 degrees.

A case where the background portion is viewed at a line-of-sight angle of 45 degrees will now be considered. The transmittance of the background portion of the second liquid crystal panel 107 is the transmittance of 0.007 corresponding to the line-of-sight angle of 45 degrees and the gradation value of 0.0 in the table shown in FIG. 4. Therefore, the perceived brightness of the background portion (the brightness of the light beam 705) is 0.002 (=0.007×0.233). As a result, when the line-of-sight angle is 45 degrees, as shown in FIG. 10B, the band 603 is observed not only in the band portion but also in the background portion at a perceived brightness of 0.002 and a double image is visible. Furthermore, when the screen is viewed at the line-of-sight angle of 45 degrees, a difference between the perceived brightness of the band portion (the brightness of the light beam 704) of 0.109 and the perceived brightness of the background portion (the brightness of the light beam 705) of 0.002 is 0.107 (=0.109−0.002). Therefore, as shown in FIG. 10B, the band 603 of the background portion (the light beam 705) appears bright and a double image becomes more visible.

FIGS. 11A and 11B are schematic views showing an example of image display according to the present embodiment. FIG. 11A shows an example of a correspondence relationship among the gradation value of linear image data, the transmittance of the first liquid crystal panel 106, the transmittance of the second liquid crystal panel 107, brightness of light incident from the first liquid crystal panel 106 to the second liquid crystal panel 107, a line-of-sight angle, perceived brightness, and the like. FIG. 11B shows an example of an image perceived when the user views the screen at a line-of-sight angle of 45 degrees.

A case where the background portion is viewed at a line-of-sight angle of 45 degrees will now be considered. The transmittance of the background portion of the second liquid crystal panel 107 is the transmittance of 0.007 corresponding to the line-of-sight angle of 45 degrees and the gradation value of 0.0 in the table shown in FIG. 4. Therefore, the perceived brightness of the background portion (the brightness of the light beam 705) is 0.001 (=0.007×0.185).

The perceived brightness of 0.001 of the band 603 in the background portion is half of the perceived brightness of 0.002 according to conventional art (FIGS. 10A and 10B). Therefore, as shown in FIG. 11B, a double image can be made less visible. Furthermore, when the screen is viewed at the line-of-sight angle of 45 degrees, a difference between the perceived brightness of the band portion (the brightness of the light beam 704) of 0.078 and the perceived brightness of the background portion (the brightness of the light beam 705) of 0.001 is 0.077 (=0.078-0.001) which is smaller than the difference of 0.107 according to conventional art. This also contributes to making a double image less visible. In this manner, a double image can be made less visible due to a reduction in the perceived brightness of the band 603 (the light beam 705) in the background portion and a reduction in the difference between the perceived brightness of the band 603 (the light beam 705) in the background portion and the perceived brightness of the band portion (the light beam 704). In other words, a similar effect to that described with reference to FIGS. 8A, 8B, 9A, and 9B can be obtained.

As described above, according to the present embodiment, image display is performed so that the viewing angle characteristics of the second liquid crystal panel 107 becomes inferior to the viewing angle characteristics of the first liquid crystal panel 106. In other words, image display is performed so that a decline in the transmittance of the second liquid crystal panel 107 due to an increase in a line-of-sight angle is larger than a decline in the transmittance of the first liquid crystal panel 106 due to an increase in the line-of-sight angle. Accordingly, a double image can be reduced. In addition, since image processing for reducing a spatial frequency of an image or the like is not particularly performed, other types of image quality deterioration (an occurrence of a halo phenomenon, a decline in contrast, and the like) can also be suppressed.

Note that the γ characteristics of the double liquid crystal panel is not limited to γ characteristics expressed as γ value=γ1+γ2=2.2. In addition, the first liquid crystal panel 106 may or may not be a liquid crystal panel capable of displaying color images. The first liquid crystal panel 106 may be a liquid crystal panel that displays monochrome images.

While an example has been described in which an increase in the gradation value causes viewing angle characteristics to deteriorate, the viewing angle characteristics may deteriorate due to a decrease in the gradation value. In this case, for example, a γ value larger than the first γ value γ1 may be used as the second γ value γ2. In addition, while an example of normally black has been described, so-called normally white may be adopted instead in which the larger the gradation value of the input image data, the lower the brightness of the input image data, the transmittance of the first liquid crystal panel 106, the transmittance of the second liquid crystal panel 107, and the like.

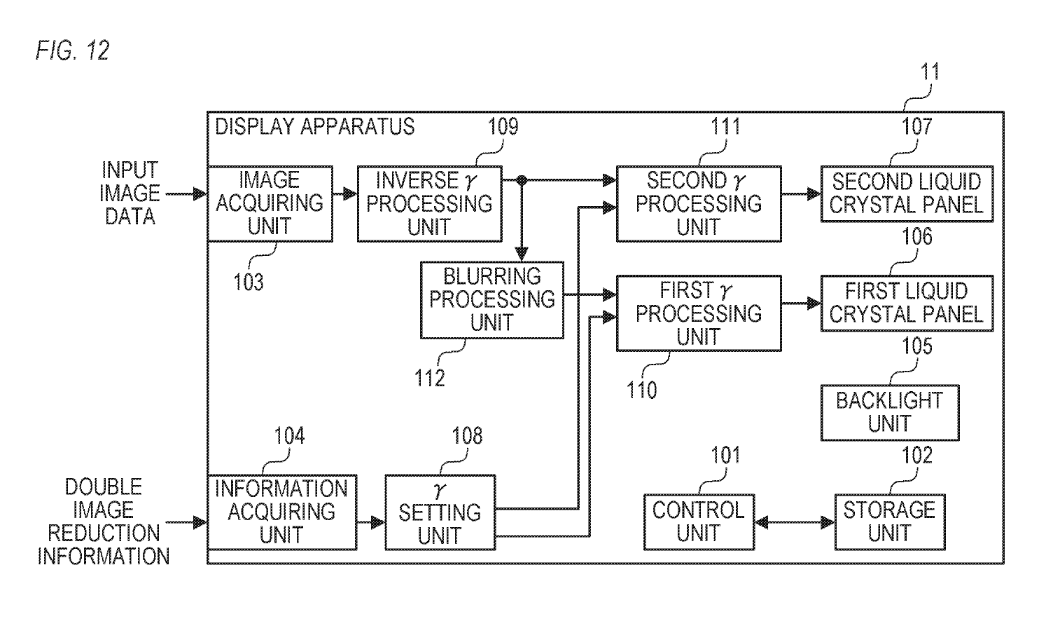

The display apparatus may execute a blurring process for obtaining first processed image data having a lower spatial frequency than a spatial frequency of second processed image data. The blurring process is, for example, a filtering process using a smoothing filter such as a Gaussian filter. FIG. 12 is a block diagram showing a configuration example of a display apparatus 11 that performs a blurring process. The display apparatus 11 includes the respective functional units of the display apparatus 10 and a blurring processing unit 112. The blurring processing unit 112 generates blurred image data by performing a blurring process on linear image data output from the inverse γ processing unit 109. In addition, the blurring processing unit 112 outputs the blurred image data to the first γ processing unit 110. Since a spatial frequency of the blurred image data is lower than a spatial frequency of the linear image data, image data with a lower spatial frequency than a spatial frequency of the second processed image data is obtained as the first processed image data. As a result, a double image can be further reduced.

Note that the first process is not limited to the γ conversion process using the first γ value γ1. The first process may include the γ conversion process using the first γ value γ1 and other image processing. In addition, the second process is not limited to a γ conversion process using the second γ value γ2. The second process may include the γ conversion process using the second γ value γ2 and other image processing.

### Second Embodiment

A second embodiment of the present invention will be described below. In the first embodiment, an example of setting a first measure (the first γ value γ1) and a second measure (the second γ value γ2) in accordance with a user operation has been described. In the present embodiment, an example of setting the first measure and the second measure in accordance with input image data will be described. Hereinafter, points (configurations and processes) that differ from those of the first embodiment will be described in detail and descriptions of points that are the same as those of the first embodiment will be omitted.

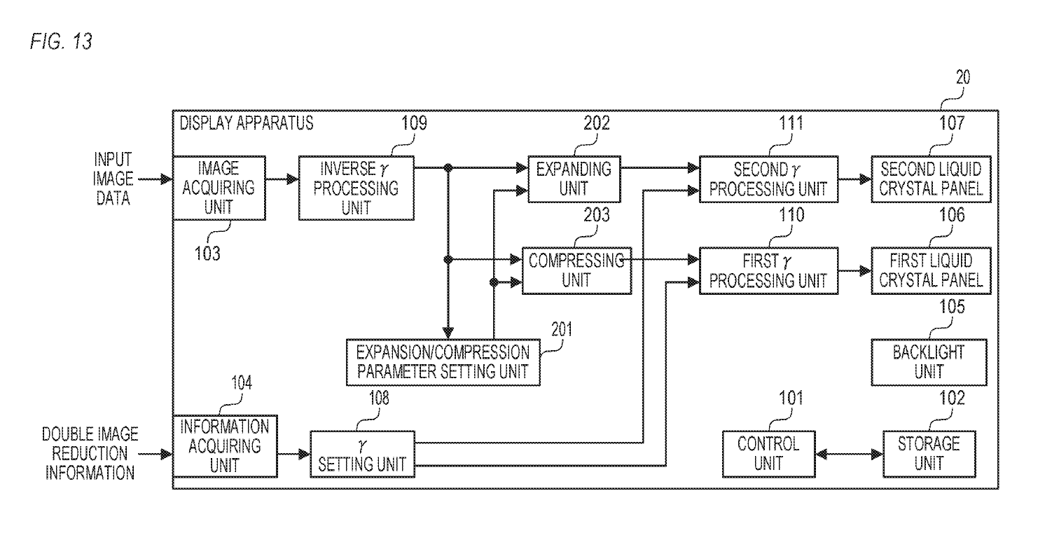

FIG. 13 is a block diagram showing a configuration example of a display apparatus 20 according to the present embodiment. The display apparatus 20 includes the respective functional units in the first embodiment (FIG. 1), an expansion/compression parameter setting unit 201, an expanding unit 202, and a compressing unit 203. Alternatively, the display apparatus 20 may not include the γ setting unit 108, the first γ processing unit 110, the second γ processing unit 111, and the like.

The expansion/compression parameter setting unit 201 sets the first measure and the second measure in accordance with input image data (specifically, linear image data output from the inverse γ processing unit 109). In the present embodiment, the expansion/compression parameter setting unit 201 determines an expansion/compression parameter in accordance with the linear image data. In addition, the expansion/compression parameter setting unit 201 outputs the expansion/compression parameter to the expanding unit 202 and the compressing unit 203. Specifically, the expansion/compression parameter setting unit 201 determines an expansion/compression parameter of each pixel using expressions 10 to 12 below. In expressions 10 to 12, “AM_R” denotes an expansion/compression parameter corresponding to an R component of an m-th row, n-th column pixel, “AM_G” denotes an expansion/compression parameter corresponding to a G component of the m-th row, n-th column pixel, and “AM_B” denotes an expansion/compression parameter corresponding to a B component of the m-th row, n-th column pixel. “a” denotes a coefficient for adjusting the expansion/compression parameter.

AM_Rmn=α×(255/GV_Rmn) (expression 10)

AM_Gmn=α×(255/GV_Gmn) (expression 11)

AM_Bmn=α×(255/GV_Bmn) (expression 12)

In the present embodiment, the expansion/compression parameter is used as a coefficient (a second coefficient) to be multiplied to the gradation value of the linear image data in order to further increase the gradation value of the second processed image data. In addition, a reciprocal of the expansion/compression parameter (the second coefficient) is used as a coefficient (a first coefficient) to be multiplied to the gradation value of the linear image data in order to further reduce the gradation value of the first processed image data. Therefore, the first γ value γ1 and the reciprocal of the expansion/compression parameter may each be described as “a part of the first measure” and the second γ value γ2 and the expansion/compression parameter may each be described as “a part of the second measure”. When the display apparatus 20 does not include the γ setting unit 108, the first γ processing unit 110, the second γ processing unit 111, and the like, the reciprocal of the expansion/compression parameter may be described as “the first measure” and the expansion/compression parameter may be described as “the second measure”. According to the expressions 10 to 12, the lower the brightness (the gradation value) of input image data, the larger the expansion/compression parameter (the second measure) that is set individually for each pixel of the input image data. As a result, the lower the brightness of the input image data the smaller the first measure to be set.

Alternatively, without using the coefficient α, a degree of deviation of the gradation value (the gradation value of linear image data) from an upper limit may be determined (set) as the expansion/compression parameter. However, with such a method, a multiplication of the expansion/compression parameter may cause the gradation value to exceed and/or be limited by the upper limit (saturation). Therefore, preferably, the coefficient α is used and the coefficient α is adjusted so that the saturation is suppressed.

Moreover, a first coefficient corresponding to the first measure may be determined as the expansion/compression parameter. The first coefficient may differ from a reciprocal of a second coefficient corresponding to the second measure.

As shown in expressions 13 to 15 below, the expanding unit 202 multiplies each gradation value of the input image data (specifically, linear image data output from the inverse γ processing unit 109) by the expansion/compression parameter output from the expansion/compression parameter setting unit 201 (expansion process). As a result, expanded image data is generated. In addition, the expanding unit 202 outputs the expanded image data to the second γ processing unit 111. In expressions 13 to 15, “VA_Rmn” denotes an expanded R value (an R value of the expanded image data) of an m-th row, n-th column pixel. “VA_Gmn” denotes an expanded G value (a G value of the expanded image data) of the m-th row, n-th column pixel. In addition, “VA_Bmn” denotes an expanded B value (a B value of the expanded image data) of the m-th row, n-th column pixel. A calculation using the expressions 13 to 15 generates the expanded image data of which a pixel value is an RGB value constituted by an 8-bit R value, an 8-bit G value, and an 8-bit B value. Moreover, a data format of the expanded image data is not particularly limited.

VA_Rmn=GV_Rmn×AM_Rmn (expression 13)

VA_Gmn=GV_Gmn×AM_Gmn (expression 14)

VA_Bmn=GV_Bmn×AM_Bmn (expression 15)

As shown in expressions 16 to 18 below, the compressing unit 203 divides each gradation value of the input image data (specifically, linear image data output from the inverse γ processing unit 109) by the expansion/compression parameter output from the expansion/compression parameter setting unit 201 (compression process). As a result, compressed image data is generated. In addition, the compressing unit 203 outputs the compressed image data to the first γ processing unit 110. In expressions 16 to 18, “VB_Rmn” denotes a compressed R value (an R value of the compressed image data) of an m-th row, n-th column pixel. “VB_Gmn” denotes a compressed G value (a G value of the compressed image data) of the m-th row, n-th column pixel. In addition, “VB_Bmn” denotes a compressed B value (a B value of the compressed image data) of the m-th row, n-th column pixel. A calculation using the expressions 13 to 15 generates the compressed image data of which a pixel value is an RGB value constituted by an 8-bit R value, an 8-bit G value, and an 8-bit B value. Moreover, a data format of the compressed image data is not particularly limited. In addition, a process of dividing a gradation value by the expansion/compression parameter may be described a “process of multiplying the gradation value by a reciprocal of the expansion/compression parameter”.

VB_Rmn=GV_Rmn×AM_Rmn (expression 16)

VB_Gmn=GV_Gmn×AM_Gmn (expression 17)

VB_Bmn=GV_Bmn×AM_Bmn (expression 18)

The first γ processing unit 110 uses the compressed image data in place of the linear image data. Accordingly, the gradation value of the first processed image data becomes smaller than the gradation value according to the first embodiment and the transmittance of the first liquid crystal panel 106 becomes lower than the transmittance according to the first embodiment. In addition, the second γ processing unit 111 uses the expanded image data in place of the linear image data. Accordingly, the gradation value of the second processed image data becomes larger than the gradation value according to the first embodiment and the viewing angle characteristics of the second liquid crystal panel 107 become more inferior than the viewing angle characteristics according to the first embodiment. According to the above, a double image can be made less visible.

As described above, according to the present embodiment, the first measure and the second measure are set further based on input image data. Accordingly, a double image can be made less visible than in the first embodiment.

While an example in which the first measure and the second measure are individually set for each pixel value of input image data has been described, this is not restrictive. For example, the first measure and the second measure may be individually set for each of a plurality of divided regions constituting the screen. The divided region may be a region in which one pixel is displayed or a region in which two or more pixels are displayed. A resolution (the number of liquid crystal elements) of the first liquid crystal panel 106 may be equal to a resolution of the second liquid crystal panel 107 or may be lower than the resolution of the second liquid crystal panel 107. In this case, each liquid crystal element of the first liquid crystal panel 106 corresponds to two or more pixels. The plurality of divided regions may be a plurality of divided regions respectively corresponding to the plurality of liquid crystal elements of the first liquid crystal panel 106. Making the resolution of the first liquid crystal panel 106 lower than the resolution of the second liquid crystal panel 107 enables a production cost of the display apparatus to be reduced. The first measure and the second measure may be set with respect to an entire screen. In other words, a pair of the first measure and the second measure may be set.

A method of setting the first measure and the second measure with respect to a divided region or the entire screen is not particularly limited. For example, the lower a maximum brightness (a maximum gradation value) of the input image data, the smaller the first measure to be set, and the lower the maximum brightness of the input image data, the larger the second measure to be set. The maximum brightness of the input image data (linear image data) is a maximum brightness in the entire screen, a maximum brightness in a divided region, or the like. With a display apparatus that emphasizes image formation such as a television apparatus, a brightness of input image data sometimes need not be reproduced. In such a case, emphasis may be placed on reducing a double image and an average brightness (an average gradation value) of the input image data may be used in place of the maximum brightness of the input image data. The average brightness of the input image data (linear image data) is an average brightness over the entire screen, an average brightness over a divided region, or the like.

While an example in which the first measure and the second measure are set in accordance with a brightness of input image data has been described, this is not restrictive. The higher a spatial frequency of image data, the more visible a double image. Therefore, in accordance with the spatial frequency of the input image data, the higher the spatial frequency of the input image data, the smaller the first measure may be set, and the higher the spatial frequency of the input image data, the larger the second measure may be set. Specifically, with respect to each of a plurality of pairs of two adjacent pixels, a gradation difference (an absolute value of a difference in gradation values of the input image data (linear image data)) between the two pixels may be calculated and the coefficient α may be adjusted such that the larger a sum of a plurality of gradation differences, the larger the value of the coefficient α. Accordingly, the larger the sum of a plurality of gradation differences, the larger the expansion/compression parameter (second measure) to be set.

### Third Embodiment

A third embodiment of the present invention will be described below. In the first embodiment, an example of setting the first γ value γ1 and the second γ value γ2 in accordance with a user operation has been described. In the present embodiment, an example of setting the first γ value γ and the second γ value γ2 in accordance with a liquid crystal panel temperature will be described. The liquid crystal panel temperature is a temperature (a parameter) related to a backlight unit-side liquid crystal panel (the first liquid crystal panel). Hereinafter, points (configurations and processes) that differ from those of the first embodiment will be described in detail and descriptions of points that are the same as those of the first embodiment will be omitted.

With progress toward higher dynamic ranges in liquid crystal display apparatuses, there is a growing demand for high-brightness display. In particular, since a backlight light source (a backlight unit) in a display apparatus using double liquid crystals requires high brightness, there is a problem in that liquid crystals on a side of the backlight light source (liquid crystals of the first liquid crystal panel) reach high temperatures and deteriorate and, consequently, attains higher transmittance than ordinary liquid crystals.

A level at which liquid crystals reach a high temperature may depend on the transmittance of the liquid crystal panel. In backlight light (light emitted from a backlight light source), light shielded by the liquid crystal panel is converted into heat on a surface and inside the liquid crystal panel. Therefore, for example, when a video signal (image data) is dark and the transmittance of the liquid crystal panel is low, a larger amount of the backlight light is shielded by the liquid crystal panel and the liquid crystal panel is more likely to reach a high temperature. Conversely, when the video signal is bright and the transmittance of the liquid crystal panel is high, since the amount of the backlight light shielded by the liquid crystal panel is small, the liquid crystal panel is less likely to reach a high temperature as compared to when the transmittance of the liquid crystal panel is low.

Therefore, in the present embodiment, a method of controlling a temperature rise of a backlight light source-side liquid crystal panel by controlling the first γ value γ1 and the second γ value γ2 will be described.

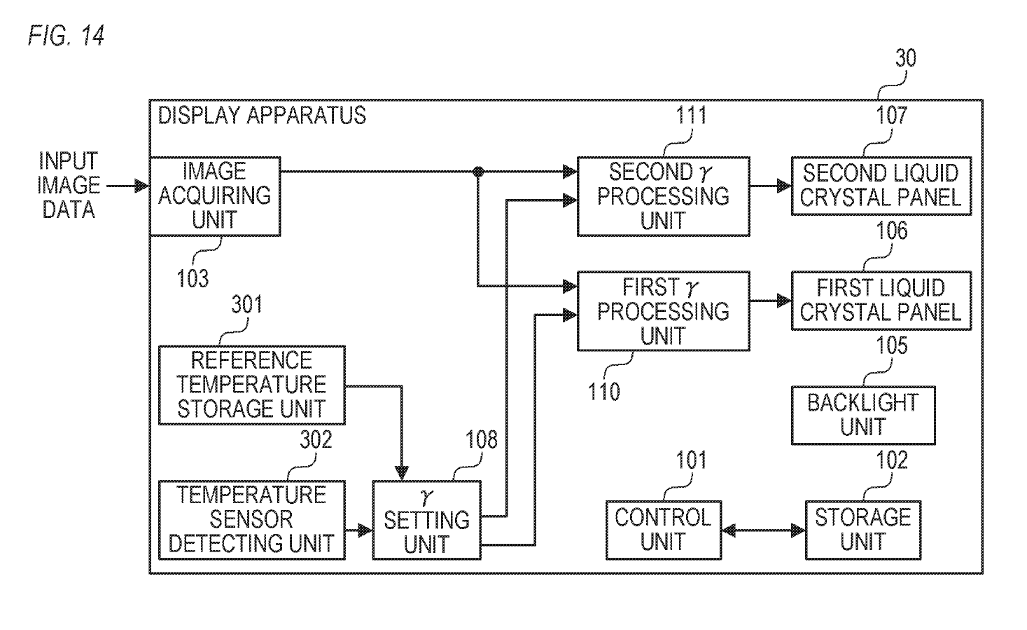

FIG. 14 is a block diagram showing a configuration example of a display apparatus 30 according to the present embodiment. The display apparatus 30 includes the image acquiring unit 103, a reference temperature storage unit 301, a temperature sensor detecting unit 302, the γ setting unit 108, the first γ processing unit 110, the second γ processing unit 111, the first liquid crystal panel 106, the second liquid crystal panel 107, the backlight unit 105, the control unit 101, and the storage unit 102. Alternatively, the display apparatus 30 may not include the reference temperature storage unit 301, the γ setting unit 108, the first γ processing unit 110, the second γ processing unit 111, and the like.

The temperature sensor detecting unit 302 detects a liquid crystal panel temperature related to the first liquid crystal panel 106 and outputs the detected liquid crystal panel temperature to the γ setting unit 108. The liquid crystal panel temperature may be a temperature of the first liquid crystal panel 106 itself or a temperature at another location (the second liquid crystal panel 107, the backlight unit 105, or the like) inside the display apparatus 30. The liquid crystal panel temperature may be an estimated temperature. An outside temperature of the display apparatus 30 or the like may be taken into consideration when estimating the temperature. The reference temperature storage unit 301 stores and retains a reference temperature to be used as a threshold when setting the first γ value and the second γ value. The γ setting unit 108 determines the first γ value γ1 and the second γ value γ2 in accordance with the reference temperature output from the reference temperature storage unit 301 and the liquid crystal panel temperature output from the temperature sensor detecting unit 302. Furthermore, the γ setting unit 108 outputs the first γ value γ1 to the first γ processing unit 110 and outputs the second γ value γ2 to the second γ processing unit 111.

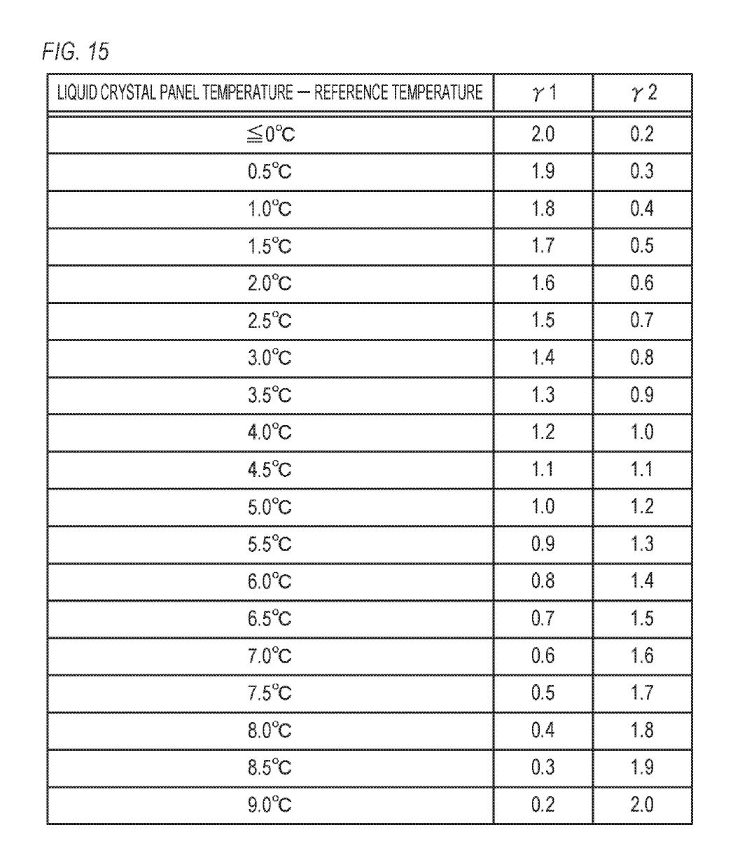

FIG. 15 is a table showing an example of a correspondence relationship between the detected liquid crystal panel temperature, the first γ value γ1, and the second γ value γ2. For example, the γ setting unit 108 determines the first γ value γ1 and the second γ value γ2 using the table shown in FIG. 15. In the present embodiment, the γ setting unit 108 respectively changes the first γ value γ1 and the second γ value γ2 when the liquid crystal panel temperature output from the temperature sensor detecting unit 302 changes within a temperature range equal to or higher than the reference temperature or changes so as to straddle the reference temperature. Specifically, when the detected liquid crystal panel temperature is equal to or higher than the reference temperature, the higher the liquid crystal panel temperature (the larger a difference between the liquid crystal panel temperature and the reference temperature), the smaller the first γ value γ1 and the larger the second γ value γ2 to be set by the γ setting unit 108. In the example shown in FIG. 15, the first γ value γ1 and the second γ value γ2 are determined so that γ characteristics of a double liquid crystal panel constituted by the first liquid crystal panel 106 and the second liquid crystal panel 107 are γ characteristics expressed as γ value=γ1+γ2=2.2.

As described above, according to the present embodiment, the first γ value γ1 and the second γ value γ2 are set based on the liquid crystal panel temperature. Accordingly, when the detected liquid crystal panel temperature is equal to or higher than the reference temperature, in accordance with an increase in the liquid crystal panel temperature, optical transmittance of the first liquid crystal panel 106 increases while the γ characteristics of the double liquid crystal panel constituted by the first liquid crystal panel 106 and the second liquid crystal panel 107 remains unchanged. As a result, since backlight light shielded by the first liquid crystal panel 106 decreases, backlight light converted into heat inside the first liquid crystal panel 106 decreases, and a temperature rise of the first liquid crystal panel 106 which is a primary cause of deterioration of the first liquid crystal panel 106 can be suppressed.

While an example of respectively changing the first γ value γ1 and the second γ value γ2 in accordance with a change in the liquid crystal panel temperature using a reference temperature as a threshold has been described, a method of setting the first γ value γ1 and the second γ value γ2 is not particularly limited. For example, the first γ value γ1 and the second γ value γ2 may be respectively changed in accordance with a change in the liquid crystal panel temperature without using the reference temperature as a threshold. In this case, the first γ value γ1 and the second γ value γ2 are respectively changed even when the liquid crystal panel temperature changes within a temperature range below the reference temperature. For example, the first γ value γ1 and the second γ value γ2 may be respectively changed in steps with respect to a continuous change in the liquid crystal panel temperature or the first γ value γ1 and the second γ value γ2 may be respectively continuously changed with respect to a continuous change in the liquid crystal panel temperature. The first γ value γ1 and the second γ value γ2 may be respectively changed when the liquid crystal panel temperature changes so as to straddle he reference temperature, and the first γ value γ1 and the second γ value γ2 may not be respectively changed when the liquid crystal panel temperature changes within a temperature range equal to or higher than the reference temperature.

### Fourth Embodiment

A fourth embodiment of the present invention will be described below. In the third embodiment, an example of setting the first γ value γ1 and the second γ value γ2 in accordance with a liquid crystal panel temperature has been described. However, depending on input image data, controlling the first γ value γ1 and the second γ value γ2 in accordance with the liquid crystal panel temperature may cause a double image to become prominent. Therefore, in the present embodiment, an example of setting the first γ value γ1 and the second γ value γ2 in accordance with the liquid crystal panel temperature and the input image data will be described. Specifically, whether or not a double image is readily visible in the input image data is determined in advance from the input image data, and γ value control similar to that in the third embodiment is only performed in a state where a double image is not readily visible. Accordingly, a temperature rise of the liquid crystal panel can be suppressed while preventing a decline in a double image. Hereinafter, points (configurations and processes) that differ from those of the third embodiment will be described in detail and descriptions of points that are the same as those of the third embodiment will be omitted.

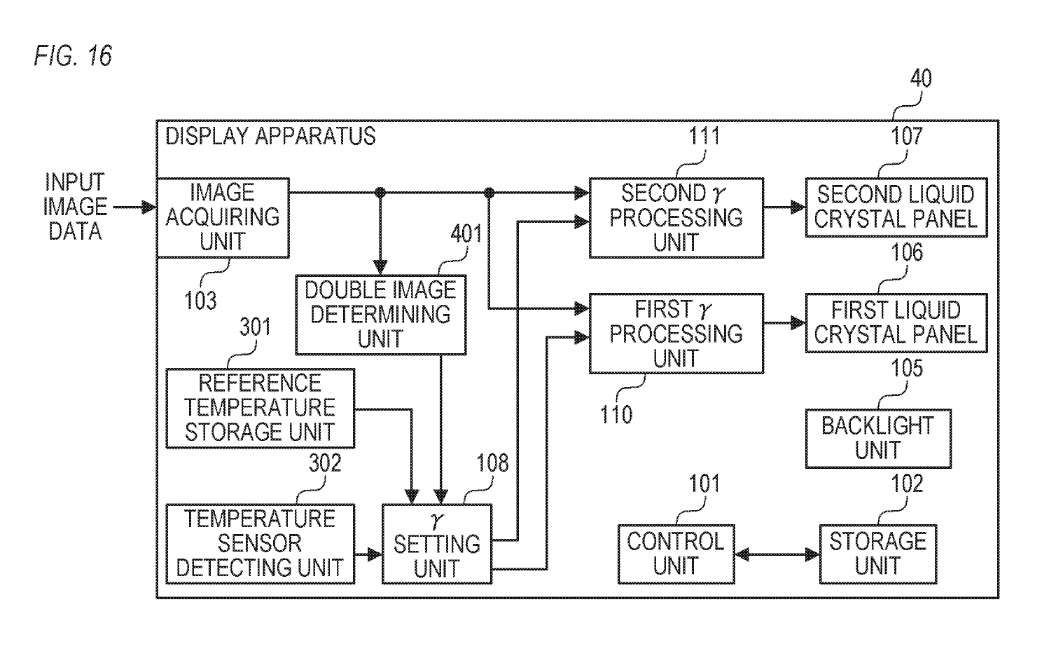

FIG. 16 is a block diagram showing a configuration example of a display apparatus 40 according to the present embodiment. The display apparatus 40 includes the image acquiring unit 103, a double image determining unit 401, the reference temperature storage unit 301, the temperature sensor detecting unit 302, the γ setting unit 108, the first γ processing unit 110, the second γ processing unit 111, the first liquid crystal panel 106, the second liquid crystal panel 107, the backlight unit 105, the control unit 101, and the storage unit 102. Alternatively, the display apparatus 40 may not include the reference temperature storage unit 301, the γ setting unit 108, the first γ processing unit 110, the second γ processing unit 111, and the like.

Based on the input image data (in accordance with the input image data) output from the image acquiring unit 103, the double image determining unit 401 determines whether or not a double image is readily visible when a person views the displayed input image data. In other words, based on the input image data, the double image determining unit 401 determines whether or not an image of which a double image is readily visible is displayed. In addition, the double image determining unit 401 outputs a determination result thereof (a double image determination result) to the γ setting unit 108. Specifically, the double image determining unit 401 performs a fast discrete Fourier transform (FFT) on the input image data and calculates spatial frequency characteristics. In this case, a maximum value among spatial frequencies in the input image data will be referred to as a maximum spatial frequency. The double image determining unit 401 determines that a double image is readily visible in the input image data and outputs 1 when the maximum spatial frequency is equal to or larger than a threshold, but otherwise outputs 0. In this case, it is assumed that the threshold can be arbitrarily set in accordance with a level of a double image to be suppressed. When the threshold is large, the double image determining unit 401 outputs 0 even in a state where a double image is relatively readily visible. When the threshold is small, the double image determining unit 401 outputs 0 only in a state where a double image is hardly visible.

The γ setting unit 108 determines the first γ value γ1 and the second γ value γ2 in accordance with the reference temperature output from the reference temperature storage unit 301, the double image determination result output from the double image determining unit 401, and the liquid crystal panel temperature output from the temperature sensor detecting unit 302. Furthermore, the γ setting unit 108 outputs the first γ value γ1 to the first γ processing unit 110 and outputs the second γ value γ2 to the second γ processing unit 111. Specifically, the γ setting unit 108 determines the first γ value γ1 and the second γ value γ2 using, for example, the table shown in FIG. 15 only when the double image determination result output from the double image determining unit 401 is 0 or, in other words, only in the case of input image data in which a double image is not readily visible. When the double image determination result output from the double image determining unit 401 is 1 or, in other words, in the case of input image data in which a double image is readily visible, the γ setting unit 108 determines the first γ value γ1 and the second γ value γ2 according to another method not based on the liquid crystal panel temperature. For example, the γ setting unit 108 controls the first γ value γ1 and the second γ value γ2 to a shared prescribed value or to individual prescribed values.

As described above, according to the present embodiment, the first γ value γ1 and the second γ value γ2 are set based on the liquid crystal panel temperature only in the case of input image data in which a double image is not readily visible. Accordingly, a temperature rise of the first liquid crystal panel 106 which is a primary cause of deterioration of the first liquid crystal panel 106 can be suppressed while preventing a double image from becoming more visible due to changes in the first γ value γ1 and the second γ value γ2.

While the use of a maximum spatial frequency has been described as a method used by the double image determining unit 401 in order to determine whether or not a double image is readily visible in the input image data, a determination method is not limited thereto. For example, a determination may be made using an average brightness in the screen.

Each functional unit according to the first, second, third, and fourth embodiments may or may not be individual hardware. Functions of two or more functional units may be realized by common hardware. Each of a plurality of functions of a single functional unit may be realized by individual hardware. Two or more functions of a single functional unit may be realized by common hardware. In addition, each functional unit may or may not be realized by hardware. For example, an apparatus may include a processor and a memory storing a control program. Furthermore, functions of at least a part of the functional units included in the apparatus may be realized by having the processor read the control program from the memory and execute the control program.

It should be noted that the first, second, third, and fourth embodiments are merely examples and that configurations obtained by appropriately modifying or altering the configurations of the first, second, third, and fourth embodiments without departing from the spirit and scope of the present invention are also included in the present invention. Configurations obtained by appropriately combining the configurations of the first, second, third, and fourth embodiments are also included in the present invention. For example, the expansion/compression parameter may be set in accordance with a user operation and the first γ value γ1 and the second γ value γ2 may be set in accordance with input image data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-216158, filed on Nov. 9, 2017, and Japanese Patent Application No. 2018-080548, filed on Apr. 19, 2018, w ich are hereby incorporated by reference herein in its entirety.

What is claimed is:

1. A display apparatus comprising:
a backlight module;
a first panel transmitting a light from the backlight module based on a first image data;
a second panel displaying an image on a display area by transmitting a light from the first panel based on a second image data; and
at least one processor and/or at least one circuit to perform the operations of the following units;
an acquiring unit configured to acquire an input image data; and
a generating unit configured to generate the first image data and the second image data based on the input image data,
wherein the generating unit generates the first image data and the second image data such that a decline in transmittance of the second panel due to an increase in a line-of-sight angle which is an angle of a line-of-sight direction relative to the display area becomes larger than a decline in transmittance of the first panel due to the increase in the line-of-sight angle.

2. The display apparatus according to claim 1, wherein
the generating unit generates the first image data by using a first gamma parameter and generates the second image data by using a second gamma parameter, and
the first gamma parameter is larger than the second gamma parameter.

3. The display apparatus according to claim 2, wherein
the at least one processor and/or the at least one circuit further performs the operations of the following units:
a setting unit configured to set the first gamma parameter and the second gamma parameter based on a user operation.

4. The display apparatus according to claim 2, wherein
the at least one processor and/or the at least one circuit further performs the operations of the following units:
a setting unit configured to set the first gamma parameter and the second gamma parameter based on a parameter corresponding to a temperature of the display apparatus.

5. The display apparatus according to claim 2, wherein
the at least one processor and/or the at least one circuit further performs the operations of the following units:
a setting unit configured to set the first gamma parameter and the second gamma parameter based on a characteristic of the input image data.

6. The display apparatus according to claim 5, wherein
the characteristic of the input image data includes at least a maximum brightness of the input image data, an average brightness of the input image data and a spatial frequency of the input image data.

7. The display apparatus according to claim 1, wherein
the generating unit generates the first image data and the second image data such that transmittance of the first panel becomes smaller than transmittance of the second panel.

8. A display apparatus comprising:
a backlight module;
a first panel transmitting a light from the backlight module based on a first image data;
a second panel displaying an image on a display area by transmitting a light from the first panel based on a second image data; and
at least one processor and/or at least one circuit to perform the operations of the following units;
a first acquiring unit configured to acquire an input image data;
a second acquiring unit configured to acquire a parameter corresponding to a temperature of the display apparatus; and
a generating unit configured to generate the first image data and the second image data from the input image data based on the parameter.

9. A control method for a display apparatus including a backlight module, a first panel transmitting a light from the backlight module based on a first image data, and a second panel displaying an image on a display area by transmitting a light from the first panel based on a second image data, the control method comprising:
acquiring an input image data; and
generating the first image data and the second image data based on the input image data,
wherein the first image data and the second image data are generated such that a decline in transmittance of the second panel due to an increase in a line-of-sight angle which is an angle of a line-of-sight direction relative to the display area becomes larger than a decline in transmittance of the first panel due to the increase in the line-of-sight angle.

10. The control method according to claim 9, wherein
the first image data is generated by using a first gamma parameter,
the second image data is generated by using a second gamma parameter, and
the first gamma parameter is larger than the second gamma parameter.

11. The control method according to claim 10, further comprising:
setting the first gamma parameter and the second gamma parameter based on a user operation.

12. The control method according to claim 10, further comprising:
setting the first gamma parameter and the second gamma parameter based on a parameter corresponding to a temperature of the display apparatus.

13. The control method according to claim 10, further comprising:
setting the first gamma parameter and the second gamma parameter based on a characteristic of the input image data.

14. The control method according to claim 13, wherein
the characteristic of the input image data includes at least a maximum brightness of the input image data, an average brightness of the input image data and a spatial frequency of the input image data.

15. The control method according to claim 9, wherein
the first image data and the second image data are generated such that transmittance of the first panel becomes smaller than transmittance of the second panel.

16. A control method for a display apparatus including a backlight module, a first panel transmitting a light from the backlight module based on a first image data, and a second panel displaying an image on a display area by transmitting a light from the first panel based on a second image data, the control method comprising:
acquiring an input image data;
acquiring a parameter corresponding to a temperature of the display apparatus; and
generating the first image data and the second image data from the input image data based on the parameter.

17. A non-transitory computer readable medium that stores a program, wherein
the program causes a computer to execute a control method for a display apparatus including a backlight module, a first panel transmitting a light from the backlight module based on a first image data, and a second panel displaying an image on a display area by transmitting a light from the first panel based on a second image data,
the control method includes:
acquiring an input image data; and
generating the first image data and the second image data based on the input image data, and
the first image data and the second image data are generated such that a decline in transmittance of the second panel due to an increase in a line-of-sight angle which is an angle of a line-of-sight direction relative to the display area becomes larger than a decline in transmittance of the first panel due to the increase in the line-of-sight angle.

18. A non-transitory computer readable medium that stores a program, wherein
the program causes a computer to execute a control method for a display apparatus including a backlight module, a first panel transmitting a light from the backlight module based on a first image data, and a second panel displaying an image on a display area by transmitting a light from the first panel based on a second image data,
the control method includes:
acquiring an input image data;
acquiring a parameter corresponding to a temperature of the display apparatus; and
generating the first image data and the second image data from the input image data based on the parameter.
